(19) United States
(12) Patent Application Publication
(10) Pub. No.: US 2008/0052377 A1
(43) Pub. Date: Feb. 28, 2008

(54) Web-Based User-Dependent Customer Service Interaction with Co-Browsing

(76) Inventor: Robert Light, Lexington, MA (US)

Correspondence Address: PATENTBEST, 4600 ADELINE ST., #101, EMERYVILLE, CA, 94608, US

(21) Appl. No.: 11/776,457

(22) Filed: Jul. 11, 2007

Related U.S. Application Data
(60) Provisional application No. 60/807,050, filed on Jul. 11, 2006.
(60) Provisional application No. 60/824,800, filed on Sep. 7, 2006.

(51) Int. Cl. G06F 15/16

(52) U.S. Cl. 709/218

(57) ABSTRACT

Systems and methods for communication between customer service representatives and users, for example, users of a website, are disclosed. In connection with rendering an informational resource, such as a World Wide Web page, on a browser, a user is provided with an indication that communication between a representative and the user is possible only if presence information for the representative indicates that the representative is available. If no representative is available, the user is provided with a null image, although the user may instead be shown the presence information for the representative expected to be available soonest. The ability to communicate with a representative may depend on the user's characteristics and history. The mode of communication offered to the user may vary, and may also depend on user characteristics, organizational preferences, and other factors. Users and representatives can also collaboratively co-browse web pages.

### CROSS-REFERENCE TO RELATED APPLICATIONS

This application claims priority to U.S. Provisional Patent Application No. 60/807,050, filed Jul. 11, 2006, and U.S. Provisional Patent Application No. 60/824,800, filed on Sep. 7, 2006. Both of those applications are hereby incorporated by reference in their entireties.

### BACKGROUND OF THE INVENTION

1. Field of the Invention

The invention relates generally to the field of computer network communication, and more particularly to methods of creating and facilitating user and customer service representative interaction using computer networks.

2. Description of Related Art

Instant messaging (IM) technology allows users on a computer network to communicate with each other in real time. Typically, users on the network have IM client software applications running on their personal computers, cellular telephones, personal digital assistants (PDAs) or other personal computing devices. When one user types a message to another user, that message is first sent to an IM server, then, optionally, through an IM server network, and reaches the other user's IM client software essentially in real time.

Using most conventional IM systems, each user is permitted to specify two types of information: his or her presence, and his or her buddies or contacts. Presence information, as the term is used here, refers to whether or not the user is available to respond to messages. A user can specify, for example, whether he or she is “available,” “away,” or “not available.” Presence information is useful because IM client software applications are generally left running in the background for long stretches of time. If a user is to be away from his or her computing device for a long period of time, he or she can set his or her presence to “away” in order to inform users that he or she will not be able to respond to messages. Additionally, in the “away” state, and occasionally in other states as well, the user can leave a message, called an “away message,” indicating where the user has gone or when he or she might be back. Away messages are generally static messages that are set by the user, like “I'll be back in 20 minutes.”

A buddy or contact list is, at its most basic level, a list of users who are able to receive and exchange presence information about each other. A typical buddy list may include a listing of a number of users and their presence information as provided by the IM servers or IM network to which they are attached. In some IM systems, buddy or contact lists also regulate which users can initiate IM chats with other users. Depending on the IM system, a user may be able to unilaterally add another user to his or her buddy list, or the addition of a user to another user's buddy list may require the consent of both users.

IM systems were originally popularized as a form of personal communication among friends that had more immediacy than electronic mail. However, as the use of IM has grown and spread, IM has become more popular in business settings as well. For example, some businesses integrate IM with their World Wide Web sites on the Internet and allow customers to contact sales or customer service representatives using IM through those Web sites.

In personal use, IM tends to be a very free-form medium with relaxed rules of etiquette and grammar. Moreover, in personal use, it may not matter whether a user is available or away, because the communication may not be urgent, and some users may actually enjoy trading creative away messages with one another.

However, when put into business use, the free-form strengths of personal IM may become weaknesses. In business use, it is generally important whether or not a customer service representative is available for an IM chat, because users who request IM chat with customer service representatives to no avail may quickly become frustrated. Furthermore, a customer service representative's time is valuable, and personal IM systems generally do not provide the customer service representative with any means to decide whether or not to answer a particular customer's messages.

Once engaged in IM communication, it may be helpful for a customer service representative to send a user to a particular World Wide Web site or other resource and to point out particular things about that Web site or resource. The process of directing a user to a particular World Wide Web site or other resource and viewing the same Web site or resource that the user is viewing is often called “co-browsing.”

Different forms of co-browsing exist. In its simplest form, co-browsing may simply involve the customer service representative sending a user a URL, which would appear in the user's IM client software, allowing the user to click on it to load the Web page. A slightly more functional approach is for the representative to “push” a Web page to the user, in which case the user's IM client software automatically causes the Web page to open. In yet more functional approaches, both IM clients are caused to open the same Web page at the same time, so that both the representative and the user can view the same Web page simultaneously.

Finally, in some very advanced co-browsing applications, the user's browser communicates with the customer service representative's browser so that the Web page that the user is viewing is exactly replicated on the customer service representative's browser and any links followed or actions performed by either party are automatically communicated to both browsers. This kind of collaborative co-browsing with exact replication can be very useful, but it is also relatively difficult to implement and is not always compatible with different types of World Wide Web browsers.

### SUMMARY OF THE INVENTION

One aspect of the invention relates to software and systems that help to ensure that a user can communicate with another user, such as a customer service representative, when presented with the option to do so. In order to address this aspect of the invention, systems and software according to embodiments of the invention may provide one or more of the features described below.

First, a server may track the presence information of all available customer service representatives and provide the user with the option to initiate communication with a customer service representative only when there is at least one customer service representative whose presence information indicates availability.

Second, when a customer service representative changes his or her presence information to “away” and provides an away message with a relative time indication, such as “back in 20 minutes,” a system according to embodiments of the present invention may convert that “20 minutes” to an absolute time in the user's local time zone.

Third, if all of the customer service representatives are “away” and have indicated when they will return, a system according to embodiments of the present invention may inform the user of the earliest time that any of the representatives is expected to return in the absolute time in the user's local time zone.

Another aspect of the invention relates to methods and systems for determining which users are able to initiate communication with other users, and what methods of communication they are permitted to use. This aspect of the invention is particularly useful where one of the users is a customer service representative and the other user is a customer. In methods and systems according to this embodiment of the invention, a customer service representative is permitted to decide whether the user should be banned from further communication with representatives in the same organization or limited to particular methods of communication. The customer service representative may also enter a grade to indicate the quality of the communication or the worthiness of the customer for further communication. Each organization has the ability to specify the minimum user grade that is required to initiate communication with a customer service representative. In one embodiment, users who do not have that grade, and are thus not worthy of communication, will not be presented with the opportunity to initiate communication. In other embodiments, users may be limited to specific forms of communication depending on their worthiness.

Yet another aspect of the invention relates to co-browsing. In the disclosed methods of co-browsing, an image representation of a designated web page is created and provided to the users. That image representation serves as a background or whiteboard on which annotations may be made. Annotations made by one user are communicated in real time to the other users.

These and other aspects, features, and advantages of the invention will be set forth in detail in the description that follows.

### BRIEF DESCRIPTION OF THE DRAWINGS

The invention will be described with respect to the following drawing figures, in which like numerals represent like features throughout the drawings, and in which:

FIG. 1 is a schematic illustration of a system according to one embodiment of the invention;

FIG. 2 is a flow diagram of a method of determining representative availability for IM communication and user worthiness of initiating such a communication according to an embodiment of the present invention;

FIG. 3 is an illustration of a portion of a web page with a graphical indication that a representative is available for IM communication;

FIG. 4 is an illustration of a portion of a web page without a graphical indication that a representative is available for IM communication;

FIG. 5 is an illustration of a portion of a web page illustrating the display of a representative away message;

FIG. 6 is a schematic illustration of a system according to another embodiment of the invention;

FIG. 7 is a flow diagram of a method of co-browsing according to one embodiment of the invention;

FIG. 8 is an illustration of a co-browsing window;

FIG. 9 is an illustration of a co-browsing window with an annotation;

FIG. 10 is an illustration of a graphical representation or icon indicating that a representative is available for an audio chat;

FIG. 11 is an illustration of a graphical representation or icon indicating that a representative is available for a video chat; and

FIG. 12 is an illustration of a graphical representation or icon that allows the user to supply his or her telephone number for callback by a representative.

### DETAILED DESCRIPTION

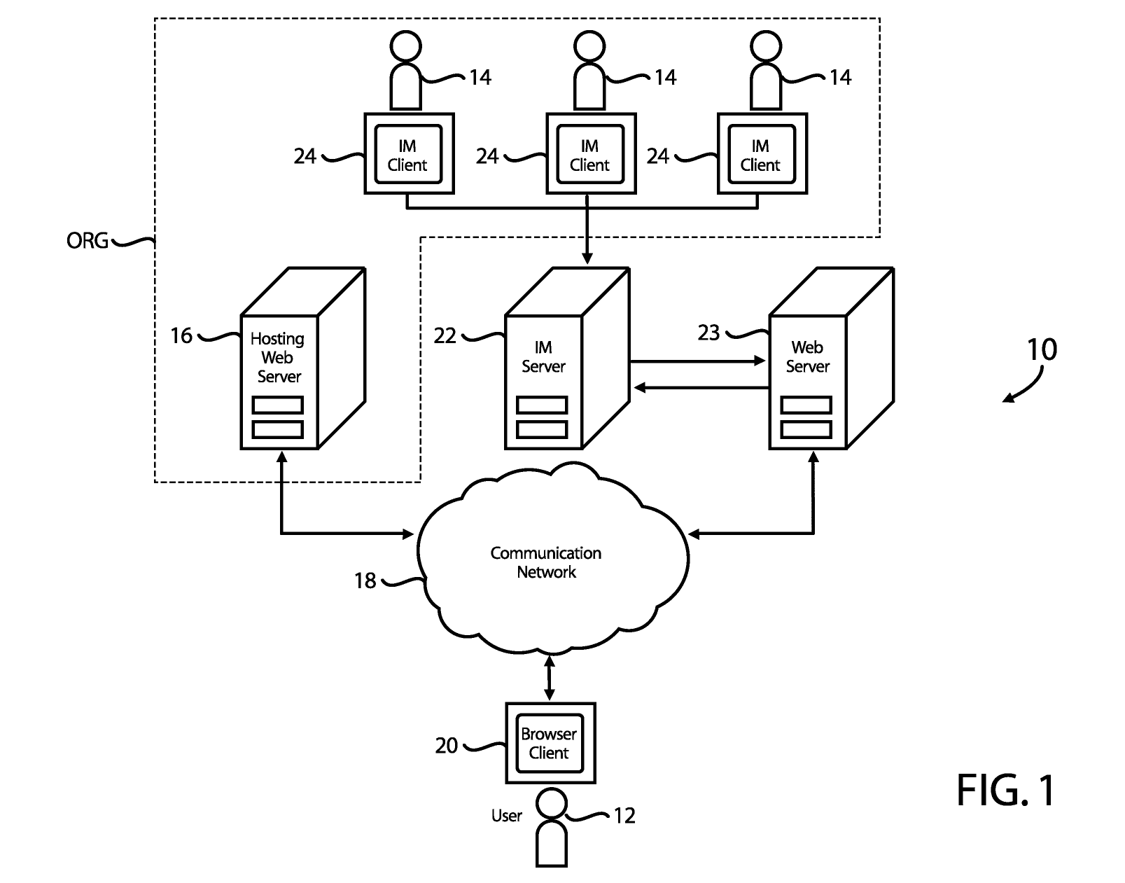

FIG. 1 is a schematic illustration of a system, generally indicated at 10, according to one embodiment of the invention. Generally speaking, system 10 is adapted for IM communication. Although some or all of the features described here may be integrated into a general-purpose IM communication system, system 10 is most advantageously used as a system for IM communication between a number of users 12 and a number of corporate or organizational representatives 14 in their professional capacities. The representatives 14 may, for example, be customer service representatives detailed to answer customer/user questions.

It should be understood that although system 10 may be adapted for IM communication, and certain embodiments of the invention will be described with specific reference to IM communication, other modes of communication may be used in and with system 10.

System 10 is most advantageously implemented as a network of computing devices. A computing device, for purposes of this description, includes any device or machine capable of performing the functions and tasks ascribed to it. Examples of computing devices include desktop and laptop computers, personal digital assistants, and cellular telephones, to name a few. Generally speaking, the functions of the devices of system 10, and other systems according to embodiments of the invention, may be performed by hardware, software, or a combination of hardware and software.

In the embodiment illustrated in FIG. 1, an organization seeking to communicate with users 12 provides a hosting web server 16 whose purpose is to deliver informational pages to users and collect information from users using appropriate machine languages and protocols. (The organization, and the elements of system 10 that are associated with it, are indicated by the dotted-line box labeled “ORG” in FIG. 1.) It should be understood that although the hosting web server 16 is described in the context of system 10 as being provided and maintained by the organization whose informational pages it serves, that need not be the case. In some embodiments, an organization may outsource the task of providing and maintaining its hosting web server 16 to another party.

The hosting web server 16 generally delivers hypertext pages to the user in HTML or XHTML using the hypertext transfer protocol (HTTP) or secure hypertext transfer protocol (HTTPS) through a communication network 18, although the hosting web server 16 may also perform additional tasks in some embodiments, and need not necessarily be a dedicated web server. The HTML pages provided by the hosting web server 16 may include JavaScript or another client-side scripting language. Moreover, the HTML pages may be static pages or pages that are generated by using a server-side language, such as PHP, ASP, Perl, or JSP. The communication network 18 itself may be a packet-switched network, such as the Internet.

In order to view the pages provided by the hosting web server 16, to submit information to the organization that maintains the hosting web server 16, and to otherwise interact with the organization, the user 12 has a browser/client 20 that is connected to the communication network 18 and is thus indirectly connected or coupled to the hosting web server 16 to receive and transmit information through the communication network 18. The browser/client 20 is typically a personal computing device, such as one of the personal computing devices described above, that is equipped with general or special purpose software for viewing information provided by the web server 16. Client browser software is known in the art, and the client browser software used in system 10 may be any browser software known in the art, including the INTERNET EXPLORER, NETSCAPE, SAFARI, FIREFOX, and OPERA browser software packages, to name a few. If the personal computing device is a cellular telephone or another computing device of limited or specialized computing abilities, the browser software may be tailored for that device. In particularly advantageous embodiments that will be described below in more detail, the browser/client 20 is capable of storing session information from interaction with the web server 16, for example, in the form of one or more cookies.

System 10 also includes an IM server 22. The IM server 22 is generally a computing device adapted to accept, process, and route instant message communications to and from a plurality of users. The IM server 22 may be a computing device running IM server software. For example, the server software may be Jabber open source IM server software (The Jabber Software Foundation, Denver, Colo., United States), although substantially any server software may be used, with appropriate modifications, in system 10.

System 10 also includes a third-party web server 23 that is in communication with the IM server 22. The third-party web server 23 is in communication with the browser/client 20 of the user 12 through the communication network 18. In particularly advantageous embodiments, the IM server 22 and third-party web server 23 are operated by a third party not affiliated with the organization operating the hosting web server 16, although in some embodiments, the organization operating the hosting web server 16 may also operate the other servers 22, 23 or provide the functions that they provide.

At the back end of system 10, the representatives 14 employed by the organization that operates the hosting web server 16 have and interact with their own IM clients 24, which are in communication with the IM server 22. Although the IM clients 24 of the representatives 14 are shown as directly connected to the IM server 22, they may be connected to the IM server 22 through a communication network, such as communication network 18, or may be connected to an interconnected network of IM servers 22. Firewalls and other protective software may also be installed between the IM clients 24 and the IM server 22 in order to insulate the IM clients 24 from the rest of the communication network 18. The IM clients 24 themselves may be any type of common IM software running on a computing device, including the AOL Instant Messenger client software, the Microsoft Messenger IM software, the Yahoo! Messenger client software, and multi-protocol IM client software, such as Trillian and Gaim.

The use of common IM software as an IM client 24 for a representative 14 is advantageous in some embodiments. For example, such an arrangement would allow a representative 14 to use the existing IM software on his or her personal digital assistant or laptop computer, allowing the representative 14 to field customer service inquiries while he or she is traveling or away from the office. This can be particularly helpful for small companies whose representatives 14 may have other duties or obligations. However, for larger organizations, it may be more advantageous if the IM clients 24 are tailored for customer service IM communication and provide that feature, along with other features and applications typically used by representatives 14 in the organization. For example, the IM clients 24 may provide the ability to handle multiple simultaneous IM conversations with different users 12, more information on the individual users 12 and their histories, and access to other customer service applications used by the same organization within the same software package.

In some embodiments, both off-the-shelf common IM software and specially tailored IM software may be used simultaneously in system 10 as the IM clients 24. In that case, more advanced features may only be available to those using specially tailored IM clients 24.

As illustrated in FIG. 1, the representatives 14 work for the same organization that maintains the hosting web server 16, and in a common embodiment, their function would be to answer user queries and address user problems. In particularly advantageous embodiments, the third-party operator of the IM server 22 and third-party web server 23 contracts with the organization to provide IM service with the features of the present invention to the representatives 14 and the users 12 of the organization's web server 16 and web site. In some embodiments, the representatives 14 may work for an organization that contracts with another organization to provide customer service.

It should be understood that although the terms “web server” and “IM server” appear in the singular in this description, their functions may be performed by two or more machines in communication and cooperation with one another. Two or more machines in communication and cooperation with one another may be configured to appear as one logical machine to all other devices that connect with them.

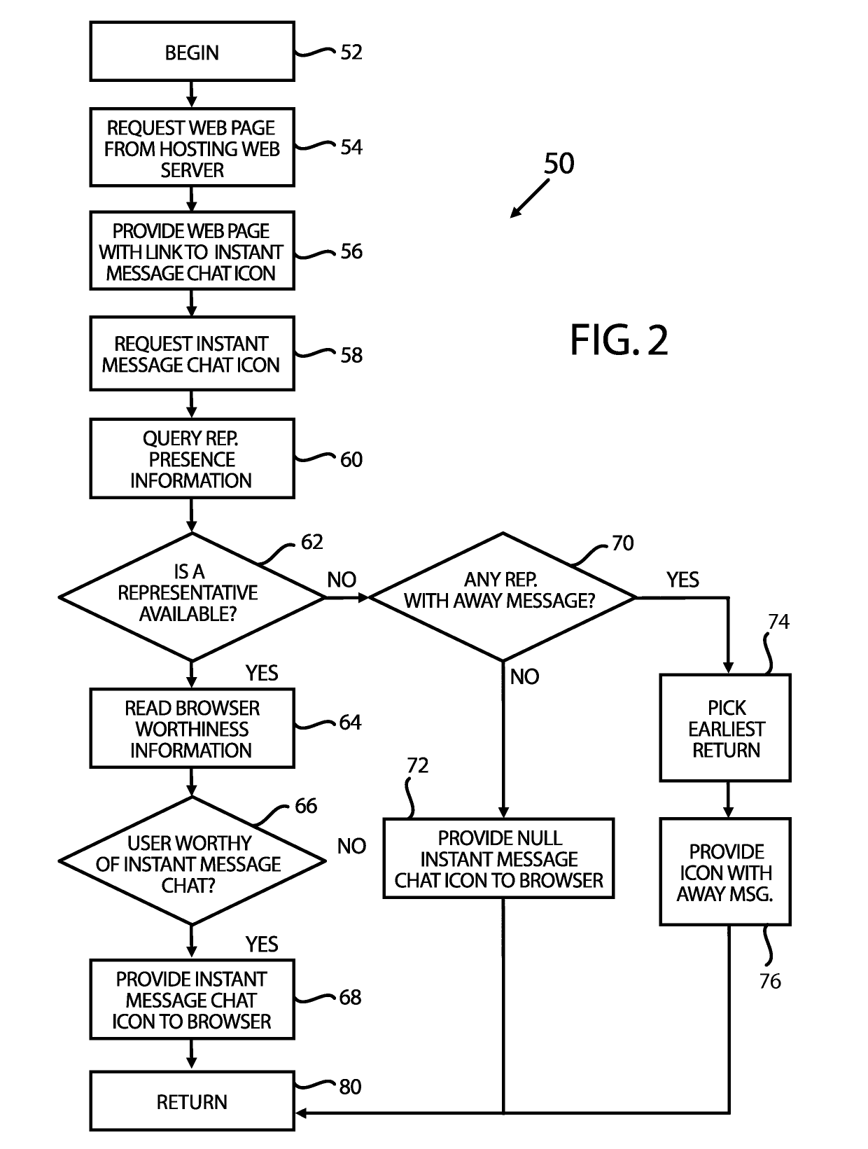

FIG. 2 is a schematic flow diagram of an embodiment of one method, generally indicated at 50, that may be performed using system 10. In general terms, method 50 is a method for determining whether and under what conditions a user 12 may initiate an IM conversation with a representative 14 using system 10. During method 50, the user's browser/client 20, while parsing and rendering a web page provided by the hosting web server 16, requests a chat icon from the third-party web server 23. If a representative 14 is available and the user is worthy of IM communication, the third-party web server 23 provides an appropriate icon indicating that IM chat is available, and that icon is rendered with the web page provided by the hosting web server 16. If a representative is unavailable or the user 12 is not worthy of IM communication, other appropriate actions are taken. Certain tasks in method 50 will be explained below assuming that the method is implemented using the World Wide Web, with HTML pages transmitted using HTTP or HTTPS, although as those of skill in the art will appreciate, other protocols and types of networks may be used with method 50.

Method 50 begins at task 52 and continues at task 54. In task 54, the user 12, through his or her client/browser 20, requests that the hosting web server 16 provide a web page. The user 12 would generally perform this task in a conventional manner, such as by typing a uniform resource locator (URL) into his or her client/browser 20. The web page requested by the user may be a main or “home” web page, or it may be a secondary web page. Once the request has been transmitted, method 50 continues with task 56.

In task 56, the hosting web server 16 returns an HTML page to the browser/client 20 using HTTP. The HTML code for that web page may cause the browser/client 20 to render any conventional HTML element, and to retrieve any conventional sort of media to appear on the rendered web page.

However, whatever other HTML elements might be present, at least once in the HTML code for the web page, a tag, set of tags, JavaScript code, or other directive or set of directives appear that direct the client/browser 20 to retrieve an IM chat icon from the third-party web server 23. In task 58, the browser/client 20, following the instructions embedded in the code for the web page, requests the IM chat icon from the third-party web server 23.

The IM chat icon is usually an image, such as a GIF, JPEG or PNG image suitable for placement on a World Wide Web page. It also serves as a hypertext link, such that an IM chat will be initiated if the user clicks on, activates, or otherwise follows the link. Typically, the tag or tags containing the directive to query the third-party web server 23 for the IM chat icon also contain instructions, for example, by way of an “onClick” expression, that tell the browser/client 20 what to do to initiate an IM chat when the IM chat icon is clicked or followed by the user 12 on the rendered web page.

One example of a suitable set of tags in HTML for the IM chat icon is:

```
<script language=“javascript”>
    document.getElementById(“IMCHAT”).src=“http://www.thirdpartyserver.
    net/assist/Icon?id=8&time=“+escape(Date( ));
</script>
<a id=“M2MA” >
    <img id=“IMCHAT” border=“0” title=“Chat via ThirdPartyServer.net”
    onclick=setTimeout(unescape(“%77indo%77.o”)+unescape(“pen%28%27http
    %3A//www.thirdpartyserver.net/assist/jsp/welcome.jsp%3Fid%3D8%26time
    %3D%27+escape%28Date%28%29%29”)+“,‘_new’,‘screenX=100,screenY=100,
    left=100,top=100,width=350,height=400,status=no,toolbar=no,location
    =no,directories=no,toolbar=no,titlebar=no,menubar=no’)”,10)></img>
</a>
```

In the example above, the JavaScript call to the document.getElementById function gets a reference to the image (later described by the html code <img id=“IMCHAT” . . . />) identifed as “IMCHAT” and tells it to download its contents (by setting its “src” property) from a third-party web server 23, which, in this example, has the domain name “www.thirdpartyserver.net.” When that call is made, the requesting URL provides the local time and date at the browser/client 20 and an identification number (e.g., “ID=8”) that allows the third-party web server 23 to identify the organization whose members are the set of representatives 14 that can respond this particular IM chat request.

The second part of the code above designates an anchor or link with the <a> tag, and instructs the browser/client 20 to place the image designated “IMCHAT,” that is, the IM chat icon retrieved from the third-party web server 23, on the page. An “onClick” attribute specifies the behavior that is to occur when the image is clicked to begin an IM chat. (The precise nature of the IM chat icon provided by the third-party web server 23 and the behavior that occurs when the image is clicked will be described below in more detail.)

The code snippet above illustrates one particularly advantageous feature. Some hosting web servers 16 have security measures in place to prevent third-party code from harming user browser/clients 20. Such security measures may, for example, block code that makes calls to the JavaScript “window.open( )” function from executing. Additionally, on the client side, many browser/clients 20 have what are commonly known as “pop-up blockers,” which are functionalities that prevent new browser windows from being opened by JavaScript functions under certain circumstances. The “onClick” attribute in the code above uses code obfuscation, in this case, by using escape characters instead of plain text and by breaking up the command string, in order to circumvent security precautions that might otherwise prevent the opening of an IM chat window. Calls to the JavaScript “unescape( )” function are used to convert the escape codes into text, and the full command is assembled by concatenating a series of strings. Additionally, the operational code is nested within a setTimeout function that delays the code from being executed until some short time after the IM chat icon is clicked, in order to thwart pop-up blockers. Depending on the embodiment, other techniques, including other forms of code obfuscation, may be used in order to ensure compatibility with the requirements of the hosting web server 16 and the browser/client 20.

Once the browser/client 20 has contacted the third-party web server 23 to request the IM chat icon, method 50 continues with task 60.

As was described above, each IM client 24 typically maintains presence information for the representative 14 associated with it. A representative 14 may manually set the presence information to “available,” “away,” or “not available.” The IM server 22 is informed of the presence information and any changes to it. In a conventional IM system, and in some embodiments of system 10, the presence information would be disseminated to those on the representative's buddy list.

In response to the query from browser/client 20, in task 60, the web server 23 requests that the IM server 22 query the presence information for the representatives 14 associated with the web server 16 or organization. Method 50 then continues with task 62, a decision task.

In task 62, the IM server 22 examines the presence information for the representatives 14 to determine if any of them have set their presence information to “available” and are thus available for IM communication. If at least one representative is available (task 62:YES), method 50 continues with task 64, which begins the process of determining whether the user is worthy of initiating an IM chat with a representative.

Generally speaking, although the vast majority of IM communications between users 12 and representatives 14 are benign and beneficial to all parties involved, embodiments of the invention recognize and provide for the fact that there are a certain number and type of situations in which IM conversations may not be benign and/or beneficial, and a user 12 who has initiated such non-benign conversations in the past should not be permitted to initiate them again. Users who are not “worthy” of initiating IM conversations generally fall into two categories: (1) users whose queries are frivolous, time-wasting, irrelevant, or repeated; and (2) users who are truly malevolent and/or abusive to the representatives 14. Of course, the behavior of users 12 generally falls in a continuum, and some users 12 may be more or less frivolous or more or less malevolent than others.

In embodiments of the invention, the third-party web server 23 stores session information on the browser/client 20 of each user 12. For example, session information may be stored in the form of one or more “cookies,” which are bits of stored information that are set by a server that the browser/client 20 accesses, remain in the browser/client 20 between sessions or web page requests, and may be examined by the server that originally set them. Every time a browser/client 20 makes contact with the third-party web server 23, the information stored in the browser/client 20 may be read and, if desired, modified by the third-party web server 23. The information in the cookies set by the third-party web server 23, which will be referred to collectively as “worthiness information,” is used to determine whether the user should be allowed to initiate an IM conversation with a representative 14. The worthiness information for a particular user is ultimately determined by representatives 14 during IM conversations with the user 12 in a manner that will be described below in more detail.

With the operator of the third-party web server 23 setting and retrieving worthiness information and contracting to provide IM service to a number of organizations, each having its own hosting web server 16, the behavior of users 12 can be tracked across a number of organizations and hosting web servers 16. Therefore, a truly malevolent user or one who has a long pattern of frivolous queries can be identified and blocked from IM communication if the misbehavior occurred on any hosting web servers 16 that refer their users 12 to the third-party web server 23 for an IM chat icon. The organizations contracting with the third party operator of the IM server 22 need not directly share information about their users 12; rather, the relevant information is collected, set, and used by the operator of the IM server 22 and third-party web server 23.

In a basic embodiment of method 50, the worthiness information for a particular user may comprise two elements: (1) the number of times or number of sites from which the user has been absolutely banned from IM communication with representatives 14 due to malevolent or abusive behavior; and (2) a grade, on a numerical or letter scale, indicating the relative usefulness or frivolity of the interaction with the user 12 in past IM communication. Other embodiments may store other relevant worthiness information, including the total number of times that the user 12 has initiated IM communication on a particular web site, the number of times that the user 12 has initiated IM communication on all sites, the number of times that the user 12 has communicated with particular representatives 14, or any other information useful in determining whether or not the user is worthy and should be allowed to initiate IM communication.

Session information may also be used to determine user worthiness to initiate communication. For example, if a user is browsing a web site and has placed a large quantity of goods in his or her online shopping cart for purchase, that user may be deemed worthy of communication in some embodiments even though the user otherwise has a poor record of communicating with representatives 14. Other session information that may be used includes the user's login id or other identification on a particular site, the amount of time a user has spent browsing a site before requesting communication, or number of pages that the user has viewed before requesting communication.

In some cases, a user 12 may be banned from communicating with a particular representative 14. This can be helpful when there is a personality conflict or a clash during an IM conversation that affects only one representative.

In task 64, the third-party web server 23 reads the worthiness information stored on the browser/client 20 that is requesting the IM chat icon. Once the worthiness information has been read, method 50 continues with task 66, in which the worthiness information is compared with pre-determined thresholds to determine whether the user 12 should be permitted to initiate an IM conversation. If the user 12 has no stored worthiness information, the IM server 22 may default to providing the opportunity for IM communication.

Different pre-determined thresholds may be set for each organization that contracts for IM chat services. Since the identity of the organization is communicated to the third-party web server 23 when the client/browser 20 requests the IM chat icon, the third-party web server 23 can retrieve any pre-determined thresholds specific to the particular organization. For example, one hosting web server 16 may require that a user 12 have been permanently banned from no more than 3 sites and have a frivolity or worthiness grade of at least a C (on a conventional A-B-C-D-F grading scale, with F being the worst) in order to initiate IM communication.

One additional aspect of the worthiness information for a particular user 12 bears on the decision in task 66. If a user is banned from IM communication on a particular hosting web server 16, that ban would typically be permanent. However, cookies generally require an expiration date, and so the expiration date for the cookie that tracks the number of permanent bans could be set to an arbitrary date far in the future, effectively making the ban permanent. In the unlikely event that the arbitrary date is reached, the third-party web server 23 need only set a new cookie with an arbitrary date farther in the future.

However, in some embodiments of the invention, the frivolity or worthiness grade for the user 12 may not be permanent. Instead, the grade may be gradually improved or upgraded over time, so that a user who once asked frivolous questions is eventually given a chance to redeem him or herself. When the third-party web server 23 examines the worthiness information in task 64, it may check the time stamp that indicates when the frivolity grade was given, and may increment the grade upwards if a predetermined time has passed. For example, if the user was given a grade of C over a month ago, the IM server 24 may increment that grade to a B before task 66 of method 50 is executed.

If, by comparing the worthiness information for a particular user 12 with the predetermined worthiness thresholds for a particular organization, it is determined that the user 12 is worthy of initiating an IM chat, method 50 continues with task 68, and an IM chat icon indicating the availability of a representative 14 for an IM chat is provided to the browser/client 20. Method 50 then terminates at task 80.

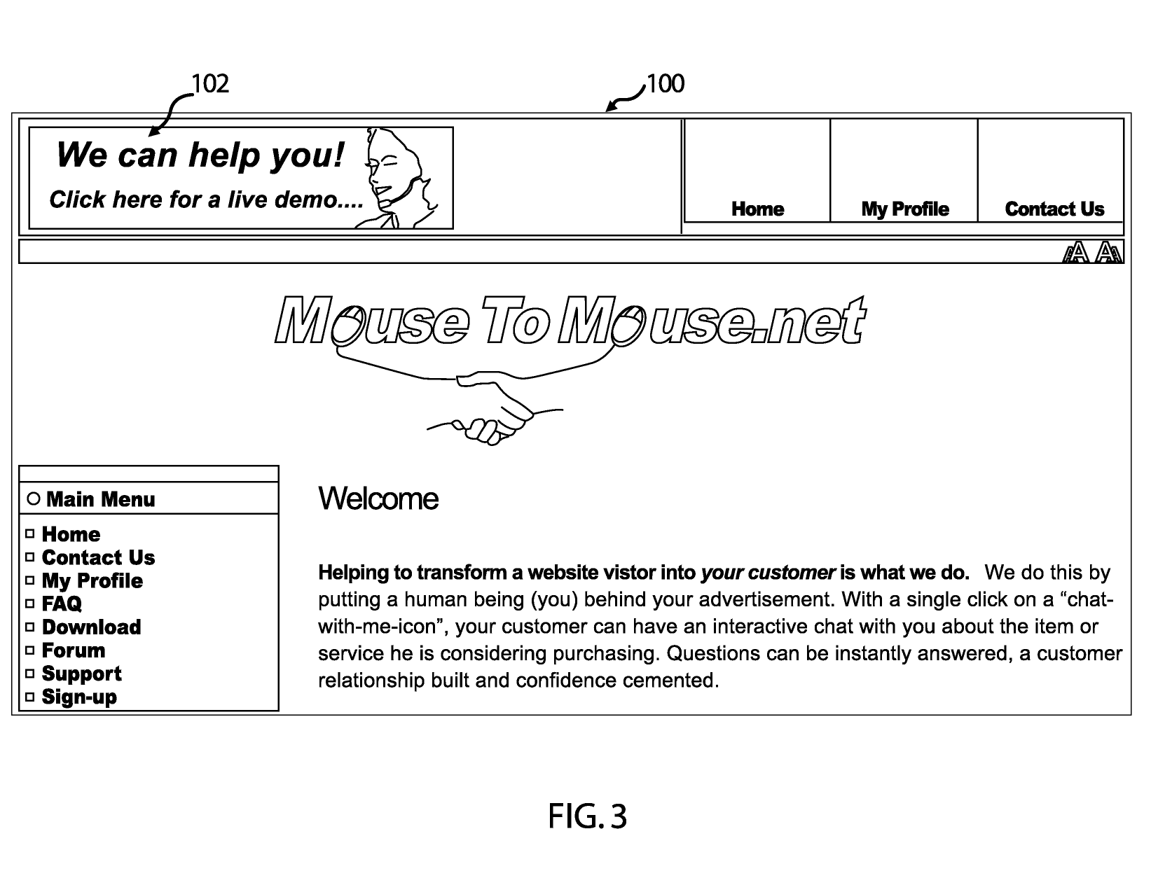

FIG. 3 is an illustration of a portion of a web page, generally indicated at 100. Web page 100 includes an IM chat icon 102, a graphical indication that a representative 14 is available for IM communication, as would be the result of task 68 of method 50. If the user clicks the graphical indication 102, an IM chat is initiated by opening a separate browser window that is in communication with the third-party web server 23. The graphical indication 102 itself may have any size, shape, or features desired. As is evident from FIG. 3, the decision that the user 12 is worthy of IM communication is transparent and is not directly reported to the user 12. In fact, in many circumstances, the user 12 may not be aware that an IM chat icon was requested and retrieved from a third-party web server 23 or that any decision making process took place.

If, in task 66 of method 50, the user 12 is not worthy of IM communication (task 66:NO), method 50 continues with task 72. In task 72, the third-party web server 23 does provide an IM chat icon, but that IM chat icon is an alternative chat icon, which in this case is a null image, such as an image with a size of one pixel by one pixel that is transparent, e.g., a 1×1 transparent GIF or PNG image. In some embodiments, rather than a transparent image, the image may contain the background color. However, regardless of the type of null image, the layout of the page is preserved and the code required to generate the HTML for the page is unchanged.

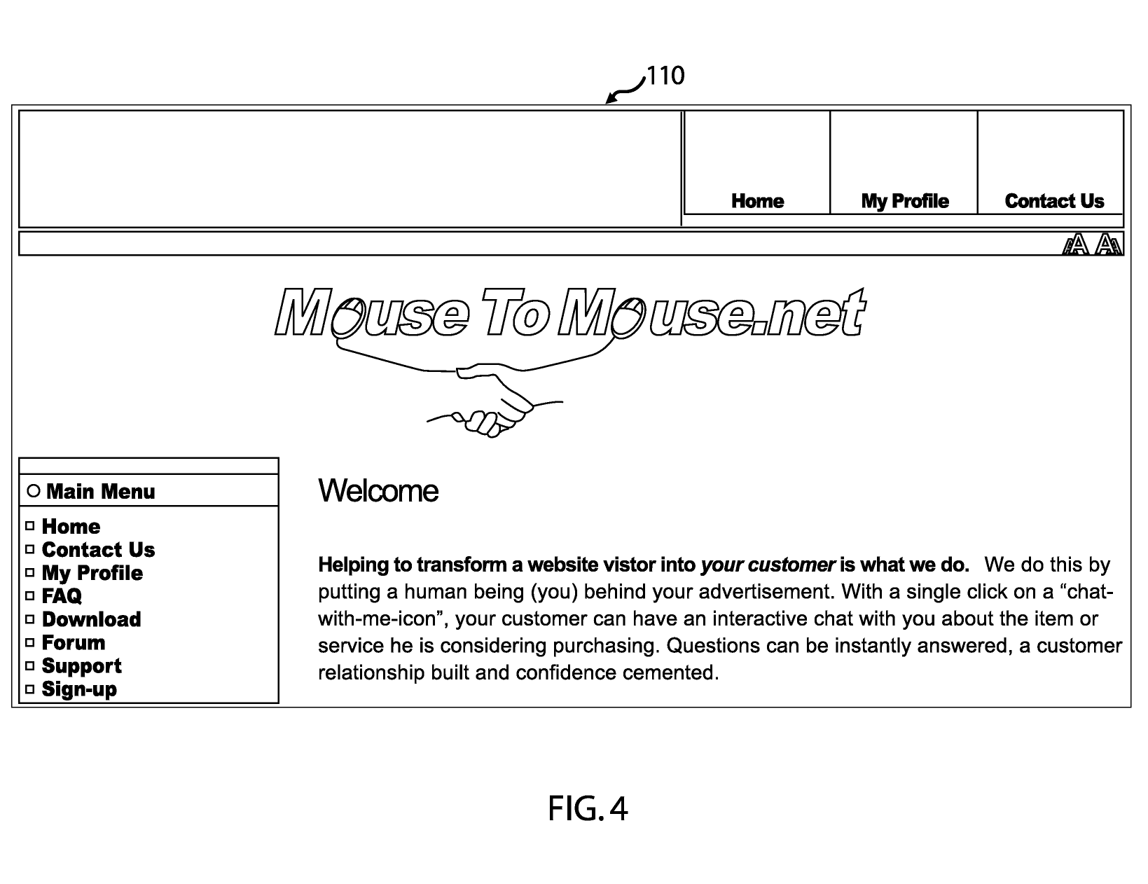

FIG. 4 is an illustration of a web page 110 that would be generated in task 66. As is evident from FIG. 4, web page 110 is identical to web page 100 except that web page 110 does not appear to contain the IM chat icon 102. In the most advantageous embodiments, the graphical indication 102 will be placed in an area where its absence will not cause notice or make users wonder whether something should be there. For example, the area on which the graphical indication 102 is placed on web page 100 contains nothing other than a black background.

As those of skill in the art will realize, the null IM chat icon, in the form of a 1×1 transparent image, is still an active link. Therefore, although highly unlikely in practice, it is theoretically possible that a user 12 could accidentally or deliberately discover the existence of the null IM chat icon and click on it. Accordingly, if a null IM chat icon is provided to a particular browser/client 20, the third-party web server 23 could take additional action to see that an IM chat cannot be initiated, for example, by ensuring that the URL or behavior specified in the onClick attribute does not cause an IM chat to be initiated if the link is followed. Additionally, if the hosting web server 16 allows JavaScript or another client-side scripting language to be included in its web pages, a script could be included that detects the null IM chat icon and disallows clicking on the link.

Embodiments of the invention also take into account the fact that representatives may not be available for IM chat. In that case, it does little good to provide an IM chat icon indicating that a representative is available. Accordingly, in some embodiments of the invention, if the representative 14 is away and has set an away message, that away message may be parsed and reported to the user in a helpful manner.

For example, in method 50, if a representative is not available in task 62 (task 62:NO), after presence information has been queried, method 50 continues with task 70, in which the IM server 22 determines whether any representatives 14 have set away messages. If any representatives 14 have set away messages (task 70:YES), method 50 continues with task 74; if no representatives 14 have set away messages, method 50 continues with task 72 and a null IM chat icon is provided, as in the above description.

Away messages such as “be back in 20 minutes” or “be back in 2 hours” are very common in instant messaging. Thus, in task 74, if more than one representative 14 has set a time-based away message, the IM server 22 picks the earliest return of the various away messages and provides the IM chat icon with the away message or a parsed version of it, as shown in task 76 of method 50. Method 50 then completes at task 80.

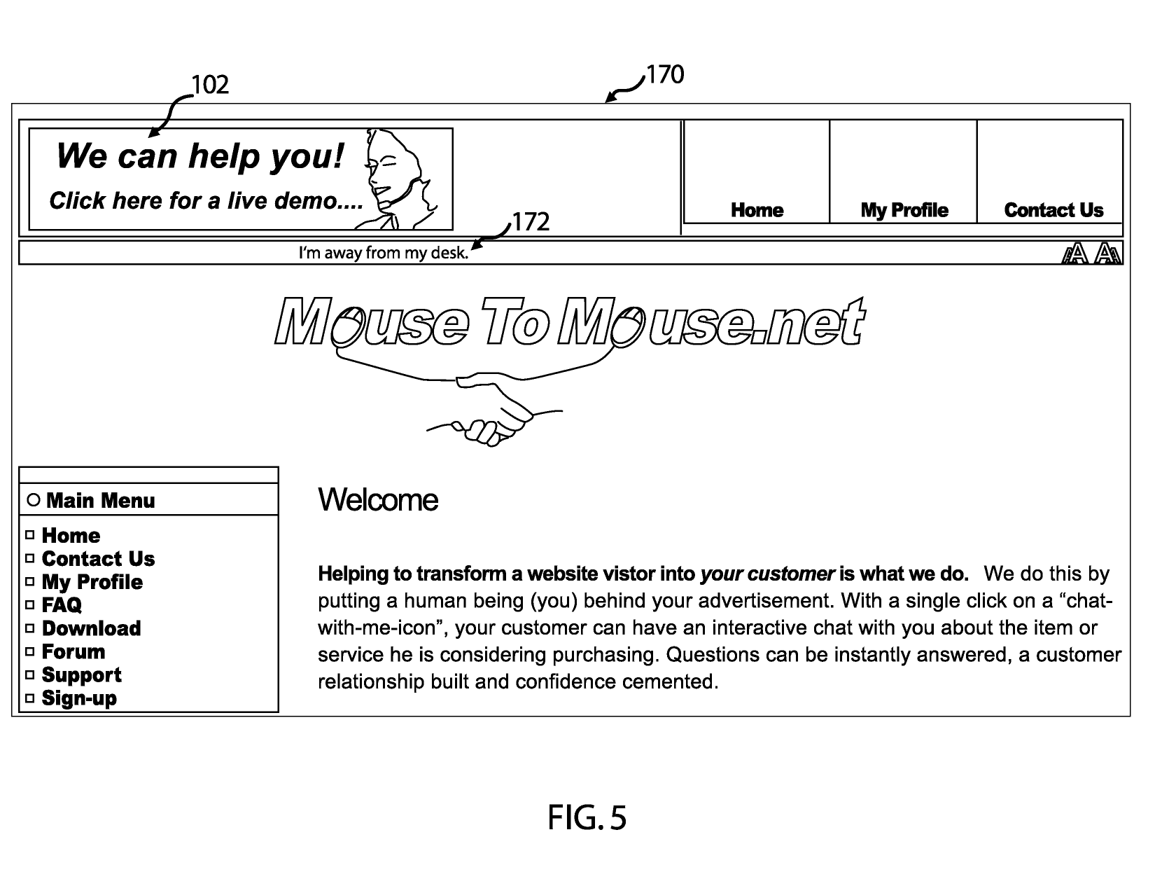

FIG. 5 is an illustration of a web page 170 that includes this feature. The IM chat icon 102 indicating the availability of IM communication is present, but in addition, an away message 172 is printed under the graphical indication 102. Depending on the embodiment, the IM chat icon 102 may be an animated image, such that the away message 172 scrolls across a portion of the web page 170. Because no representative 14 is available, if an IM chat icon 102 with an away message 172 is provided, the third-party web server 23 may also take action to see that if the IM chat icon 102 is clicked, no IM chat will result. For example, if the user 12 clicks on the IM chat icon 102, the browser window that opens in response could indicate that no representative is available, or provide a window to send an e-mail or contact a representative by some other mode of communication.

Task 76 of method 50 includes one additional feature. The person setting a time-based away message such as “be back in 20 minutes” knows when the message was set and when he or she will return, but such a message typically does very little good for others, who may have no idea when the message was set or what the beginning of the specified time period is.

In task 76, before an IM chat icon 102 with an away message 172 is provided, the away message is parsed. If the away message contains a trigger phrase with a relative time indication, such as “be back in 20 minutes,” the IM server 22 or third-party web server 23 converts it to an absolute time in each user's local time zone using the time zone information provided when the request for the IM chat icon was made in task 58 and information from the IM server 22 indicating when the presence information was set. For example, if a message of “be back in 20 minutes” was set at 12:40 PST in the United States (according to the IM server 22, which is informed of the change in presence information when the change is made), and the requesting browser/client 20 is in the eastern time zone, the away message would be converted to “back at 4:00 PM” for that browser/client 20.

The trigger phrase that causes the time conversion may be any phrase, such as “be back in ___ minutes/hours.” Depending on the embodiment, there may be several different trigger phrases. Generally, representatives 14 would be trained to use one of the trigger phrases when setting a relative time away message.

Depending on the embodiment, away messages may also be parsed for certain key words or phrases indicating that the away message is inappropriate for inclusion with an IM chat icon.

The above description of method 50 assumes that availability and user worthiness are both considered when deciding whether to allow IM communication.

However, in some embodiments, the two features may be decoupled, so that only availability of a representative 14 is taken into account, not the worthiness of the user 12. In that case, method 50 would proceed directly from task 62:YES to task 68. Additionally, if a representative 14 is not available in task 62, the web server 23 may read the browser worthiness information, as in task 64, in order to ensure that an unworthy user will not be provided with an active IM chat icon and away message.

If the browser/client 20 is provided with an IM chat icon indicating that a representative 14 is available for IM communication and the user 12 ultimately clicks on it, typically, a new browser window is opened that communicates directly with the third-party web server 23. The third-party web server 23 conveys instant messages from the browser/client 20 to the IM server 22, which communicates those messages to the IM client 24 of the representative 14. Instant messages from the representative 14 are sent from the IM client 24 to the IM server 22 and then to the third-party web server 23 for delivery to the browser/client 20 window.

The IM server 22 may provide the representative 14 with information on the user 12 at the beginning of the conversation. The IM server 22 may also provide a macro language that enables the use of predetermined or “canned” responses and allows the representative to enter or alter worthiness information for the user. For example, at the outset of the conversation, a representative might be provided with information like the following:

### System:

User jdoe621 has requested an IM chat.
Total number of IM chats on this site: 3.
Total number of IM chats on all sites: 10.
Total number of permanent bans: 1.
Overall IM grade: B-.

At any point during the conversation, the representative would be permitted to enter a command that produces a canned response or to enter a command to alter the user's worthiness information by using the macro language. In general, the macro language would be comprised of an attention character, which is a character not generally used in conversational IM communication, such as {, followed by a command portion. An example of a type of macro language is given in Table 1.

TABLE 1
Exemplary Macros

| Command | Type | Result |
|---|---|---|
| {hi | Canned response | Typed message: “Hello, my name is |
| | | John Doe, and I'm a customer service |
| | | representative for Widgets, Inc. |
| | | How may I help you?” |
| {bye | Canned response | Typed message: “Thank you for |
| | | speaking with me today. I hope that |
| | | our chat answered your questions and |
| | | resolved your problems. If there's |
| | | anything else that we can do for |
| | | you, please let us know. Have a |
| | | good day.” |
| {ban | Command | Restrict the user from further |
| | | communication with that particular |
| | | representative. Appropriate cookie |
| | | set on user's client/browser. |
| {ban all | Command | Ban the user from any further IM |
| | | communication on the site. |
| | | Appropriate cookie set on user's |
| | | client/browser. |
| {grade [A-F] | Command; | User's frivolity grade is set or |
| | representative | reset to the entered grade. |
| | enters a grade | Appropriate cookie set on user's |
| | with the | client/browser. |
| | command. | |

Macro languages and the use of canned responses are generally known in the art, and any canned responses desired may be integrated into the macro language. Moreover, the macro language may have any sort of syntax. Additionally, depending on the arrangement of system 10, IM server 22 may be programmed with a slightly different version of the macro language for each IM client 24 or organization with which it connects and interacts. For example, the IM server 22 could be programmed with different canned responses for each organization.

In some embodiments, it may be advantageous to secure communications between the browser/client 20 and the third-party web server 23, between the third-party web server 23 and the IM server 22, and between the IM server 22 and the IM client 24 operated by the representative. That would ensure that any personal or financial information could be discussed in confidence. A number of encryption systems and methods are known in the art, and any of these may be used in embodiments of the invention.

Once engaged in IM communication, it may be desirable for a representative 14 to point the user 12 to a particular World Wide Web site or other Internet resource and co-browse with the user 12. For example, a representative 14 and a user 12 may wish to examine an online statement of account together, or the representative 14 may wish to show the user 12 a particular web page and instruct the user 12 in its use. In some embodiments of the invention, a collaborative co-browsing capability may be included that allows the user 12 and the representative 14 to view and annotate the same web page or a representation of it.

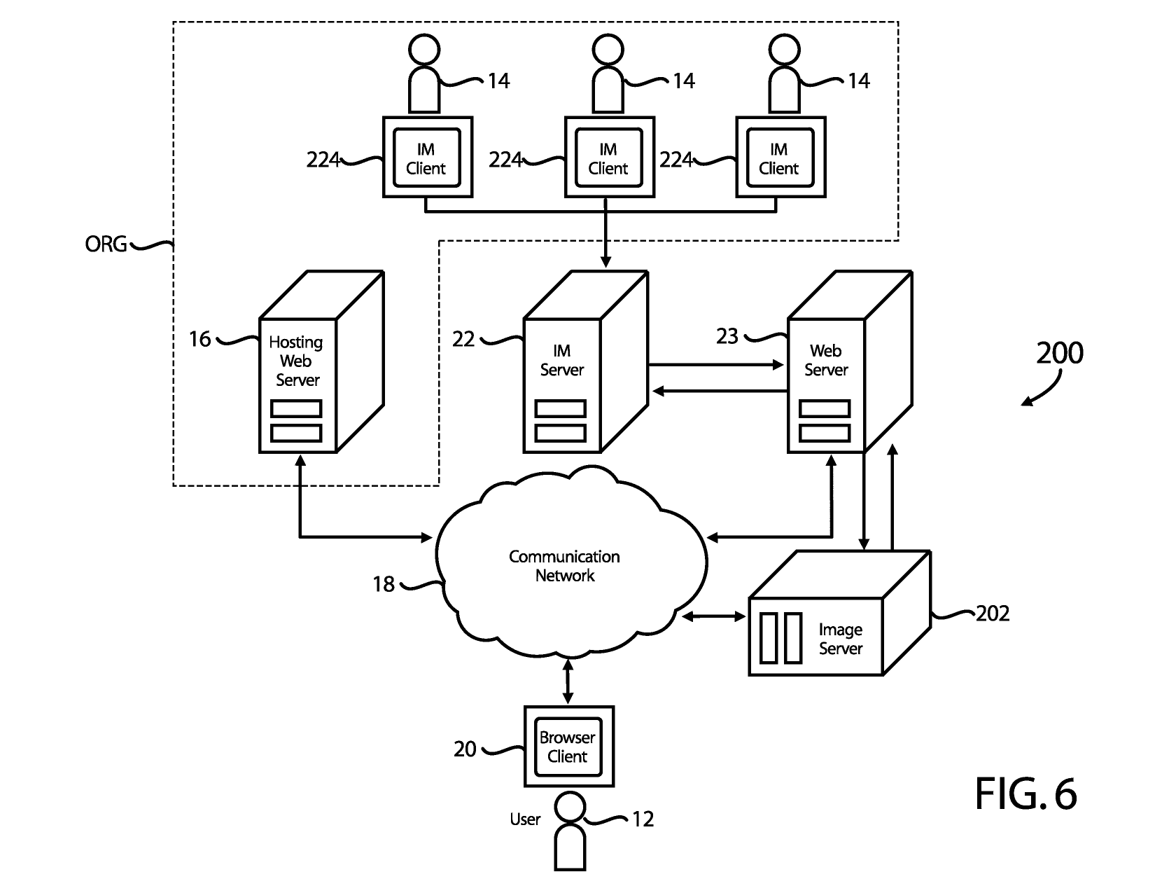

FIG. 6 is a schematic illustration of a system 200 according to another embodiment of the invention. System 200 is equipped for collaborative co-browsing but is otherwise substantially similar to system 10. Therefore, except as noted, the components of system 200 may be assumed to be the same as those in system 10.

Most advantageously, the co-browsing features of system 200 allow both the user 12 and the representative to view an image representation of a web page or other Internet resource and to sketch on or otherwise annotate that image representation while engaging in instant message or some other form of communication. Providing an image representation of a web page to the user 12 and the representative 14, rather than allowing the user 12 and the representative 14 to collaboratively co-browse an actual web page, reduces the complexity of system 200 and allows the collaborative co-browsing feature to be compatible with a wider selection of browser/clients 20. Essentially, an image representation of a web page becomes a whiteboard for annotation, collaboration and communication between the representative 14 and the user 12.

More specifically, viewing an image representation of a web page may simplify system 200 because each web browser, and each installation of a particular web browser, may render the same web page slightly differently. Fonts and form elements may be displayed differently, elements may be laid out slightly differently, and embedded objects, such as Macromedia Flash objects, may be represented differently in different browsers. These issues may make it difficult to ensure that two browsers really are showing the same web page. However, preparing an image representation of the web page largely overcomes these issues.

In order to support the co-browsing feature, system 200 includes an image server 202 whose purpose is to access a web page, render it, and prepare an image version of the rendered web page. The image server 202 is connected to the third-party web server 23 and also to the communication network 18. Of course, in some embodiments, the image server 202 and the third-party web server 23 may be made to appear and function as one logical machine, or the functions of the image server 202 may be integrated into the third-party web server 23 altogether.

The image server 202 is capable of rendering a web page or other Internet resource as it would appear to a browser/client 20 and preparing an image of that rendered web page or Internet resource. This is done by interpreting the HTML or other code that defines the web page. In one embodiment, the image server 202 may be a Macintosh computer (Apple, Inc., Cupertino, Calif., United States) with the OS X operating system, equipped with Paparazzi 0.4.3 software for URL rendering and image capture and the Apache webserver for delivery of the resulting image. Other software and systems may be used for image rendering and capture in other embodiments and, as was noted above, the image server 202 may be integrated into the third-party web server 23 in some embodiments.

Assuming that the image server 202 is physically separate from the third-party web server 23, the image server 202 may be connected to the third-party web server 23 by a local area network or it may be connected through a wide area network. The image server 202 may or may not be co-located with the third-party web server 23. In order to facilitate communication, the image server 202 may also be equipped with appropriate networking and server software so that it can respond to requests from the third-party web server 23. For example, the operating system of the Macintosh computer described above is typically equipped with Web server software, and can also interface via a number of other networking protocols. The use of the image server 202 will be described in greater detail below.

System 200 also includes IM clients 224, which are used by the representatives 14. As was described above, the IM clients 24 of system 10 can be either commercial, off-the-shelf instant message programs or special-purpose applications that include other functionality. In contrast to the IM clients 24 of system 10, the IM clients 224 of system 200 are generally also capable of co-browsing a web site with a user 12. Therefore, IM clients 224 may include at least the ability to view an image, annotate the image, communicate image annotations to the other elements of system 200, and receive image annotations made by a user 12 from other elements of system 200. Those functionalities will be explained in greater detail below. In some embodiments, the IM clients 224 may include full-fledged Web browsing capabilities along with other functionalities. In other embodiments, the IM clients 224 may comprise Web browsing software, with or without additional functionalities. Depending on the embodiment, the IM clients 224 of system 200 may be in communication with the IM server 22, the third-party web server 23 or both the IM server 22 and the third-party web server 23.

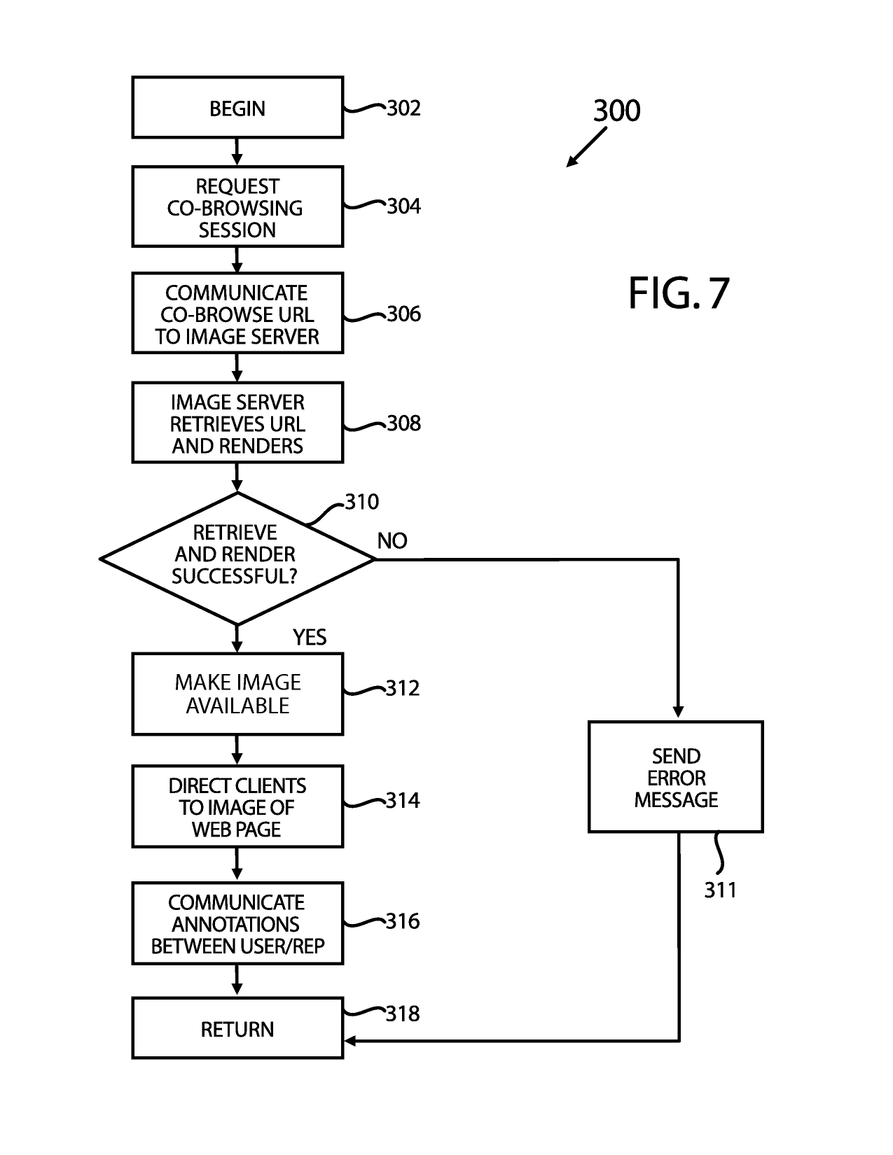

FIG. 7 is a flow diagram of a method 300 for collaborative co-browsing and IM communication using system 200. The description of method 300 that follows assumes that prior to the beginning of method 300, a user 12 has begun a conversation with a representative 14. Depending on the embodiment, that conversation may have been initiated as described above with respect to system 10 and method 50, or it may have been initiated in some other manner. In other words, the features described above with respect to system 10 and method 50, while desirable, do not necessarily need to be used in conjunction with the collaborative co-browsing features offered by system 200, and may be used separately.

Method 300 begins at 302 and continues with task 304. In task 304, either the user 12 or the representative 14 decides that a collaborative co-browsing session is desirable, designates a web page to be browsed by indicating an appropriate URL, and requests a co-browsing session. Although either party may designate a URL and begin a collaborative co-browsing session, in some embodiments, restrictions may be placed on the ability of the user 12 to initiate such a session. For example, if the representative 14 is using an IM client 24 that does not have co-browsing capability, such as a Personal Digital Assistant (PDA), the user 12 may be prevented from initiating a co-browsing session.

Once a request to begin a collaborative co-browsing session is received, method 300 continues with task 306. In task 306, the URL is communicated to the image server 202. Generally, URLs and collaborative co-browsing requests from the representatives 14 would be routed from the IM clients 224 through the IM server 22 and/or the third-party web server 23 to the image server 202. Conversely, requests from the user 12 would be routed from the browser/client 20 through the communication network 18 and to the image server 202 through the third-party web server 23, although the precise routing depends on how the components are connected, the particular communication protocols in use, and how the user 12 interacts with system 200. As one example, the request for a co-browsing session could be sent from the IM client 224 to the third-party web server 23, which would forward the URL to the image server 202 by sending a specific HTTP query that includes the URL to the image server 202.

Method 300 continues with task 308, in which the image server attempts to retrieve and render the requested URL. As shown in FIG. 6, the image server 202 is connected to the communication network 18 in order to allow the image server 202 to access the URL and retrieve the web page. The particular manner in which the URL is caused to be retrieved and rendered is not critical, so long as the URL is retrieved and the web page is rendered when needed.

When task 308 of method 300 is carried out, it is possible that the image server 202 may not be able to retrieve and render the URL as a web page. For example, the web page may be unavailable, the web server that provides the web page indicated in the URL may be busy and unable to serve it, or there may be some defect in the code that defines the web page, so that the image server 202 is unable to render it. Therefore, task 310 of method 300 is a decision task in which it is determined whether or not the image server 202 was able to retrieve and render the requested URL for co-browsing. If the image server 202 was unsuccessful (task 310:NO), an error code is communicated to the user 12 or the representative 14, depending on who made the request for co-browsing, at task 311 before method 300 terminates at task 318. Depending on the nature of the error code, in some embodiments, task 308 may be repeated several times before method 300 terminates. If task 308 is successful (task 310:YES), method 300 continues with task 312.

In task 312, the rendered web page is made available to parties in the chat by capturing it as an image and storing that image in a particular path on the image server 202 where it is accessible at a specific URL. Alternatively, an image may be captured, and the captured image may be communicated to and stored on the third-party web server 23. The precise storage location of the captured image is not critical to the invention, so long as the captured image is accessible at a particular URL or location. The image itself may be in any format compatible with the browser/client 20 and IM client 224, including JPEG, GIF and PNG formats.

As one example of the flow of tasks 306-312, if the image server 202 is the Macintosh computer described above, the third-party web server 23 may send an HTTP query with the URL that is to be retrieved, rendered, and captured as an image. That query may trigger a script on the image server 202, such as an AppleScript, that causes the Paparazzi software program to activate, retrieve the web page at that particular URL, capture the rendered page as an image, and save the captured image so that it is accessible at a particular URL.

Method 300 then continues with task 314. In task 314, the co-browsing session is formally initiated and both the browser/client 20 of the user 12 and the IM client 224 used by the representative 14 are directed to open the URL of the image that has been stored by the image server 202. Thus, instead of loading a web page, the browser/client 20 and the IM client 224 load an image (for example, a PNG) representation of that web page, as seen and rendered by the image server 202.

There are different ways of implementing task 314. For example, if the user 12 and representative 14 have been communicating as in method 50, the user may see a text message stating, for example, that “[Representative name] has initiated a co-browsing session, the co-browsing window will now appear.” At that time, a special window would be opened (either separately or embedded in the current window) for the co-browsing activity. The advantage of the embedded window approach is that it avoids any interference by popup blocking functionalities that might prevent a new window from being opened.

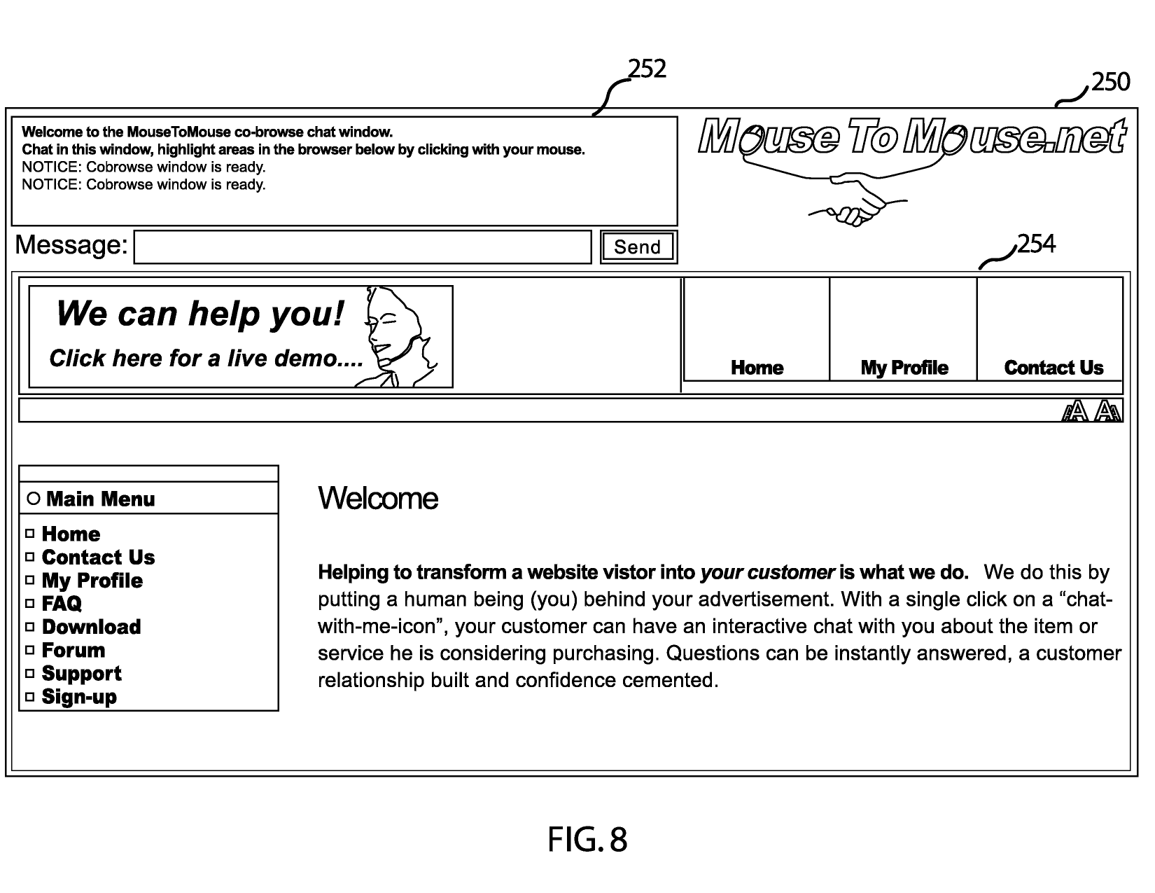

FIG. 8 is an illustration of a window 250 that may be used for IM communication as well as co-browsing. The window 250 includes an IM space 252 for entering text and viewing messages, as well as a space 254 in which the image representation of the web page that is being co-browsed is displayed. IM messages between the user 12 and the representative 14 are conveyed between the IM client 224 and the browser/client 20 as described above.

With an image representation of a web page displayed, the user 12 and representative 14 can thus converse about it. In some embodiments, that may be the extent of the co-browsing capabilities. However, as was noted briefly above, it is advantageous if the image representation of the web page can be annotated by the user 12 or the representative 14 and can thus serve as a collaborative whiteboard for a discussion.

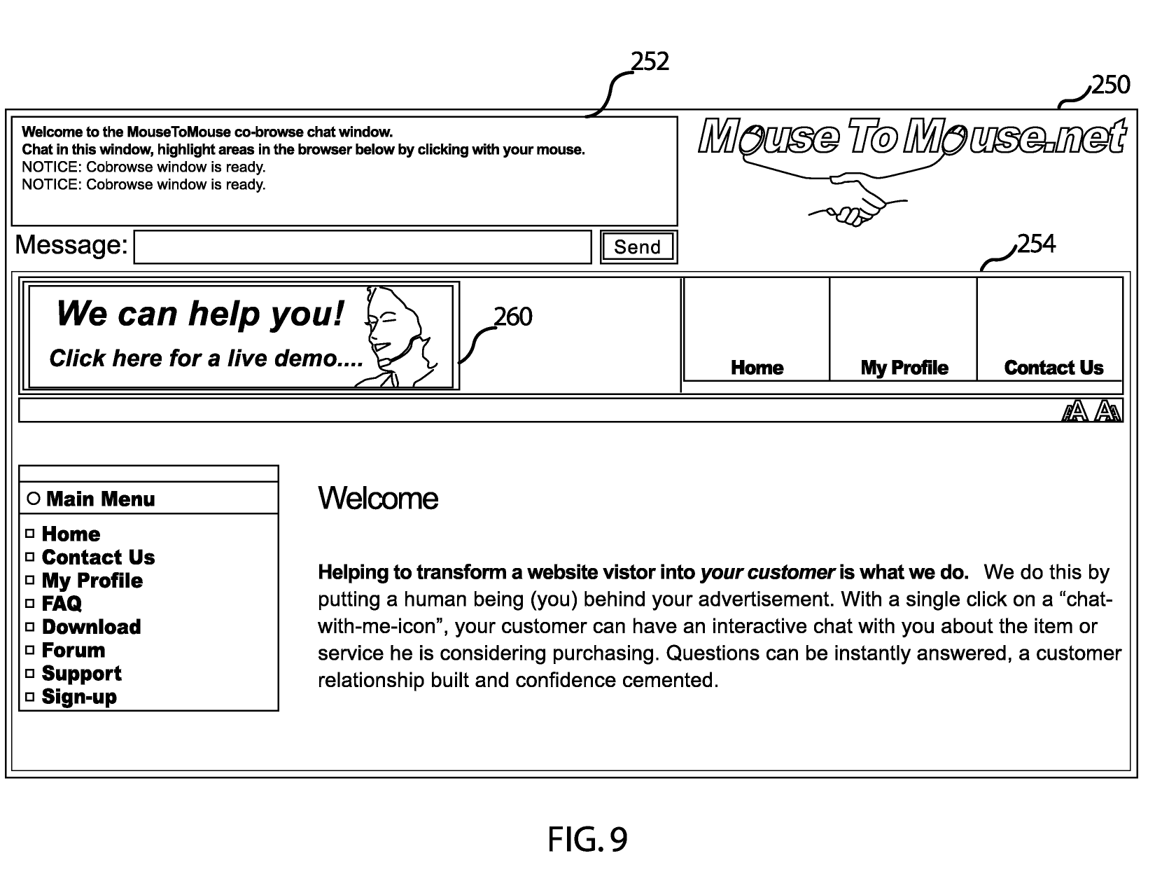

Therefore, as shown in task 316 of method 300, once a co-browsing session has been initiated, the browser/client 20 and the IM client 224 most advantageously allow the user 12 and the representative 14 to make annotations on the image representation of the web page and communicate those annotations between themselves, so that the user 12 can see annotations made by the representative 14 and vice-versa. For purposes of this description, an annotation may include anything drawn on the image representation of the web page, including text, shapes (including circles, polygons, and free-form shapes), curves, free-form lines, coloration, or any other visual or textual element that can serve to communicate. Certain other actions may also be registered and communicated between the browser/client 20 and the IM client 224. For example, if the user 12 scrolls down in his or her browser/client 20 to show a particular part of the image representation, the IM client 224 may automatically scroll to that part of the image representation. FIG. 9 is an illustration of the window 250 of FIG. 8 with an exemplary annotation 260, in the form of a semitransparent square, overlaid on the image.

There are technologies that allow a client, such as browser/client 20, to exchange small amounts of data with a web server, such as third-party web server 23, as required, instead of re-loading a web page every time the web page is changed or some action is taken. These technologies would be used in order to implement task 316 of method 300 and exchange information about annotations to the image representation of the web page during co-browsing without re-loading the page. In general, data exchange technologies rely on a combination of a scripting language to change the appearance of the web page and a data description language (with associated communication protocols) to communicate the changes between client and server.

Of the available technologies, the Google Web Toolkit (Google, Inc., Mountain View, Calif., USA) is particularly advantageous. The Google Web Toolkit allows asynchronous XML/JavaScript applications (also called AJAX applications) to be created in the Java programming language and complied to run as JavaScript.

As one example of how the annotation communication can be implemented, a set of scripts, such as a JavaScripts, can be created and executed so that when the user clicks on the image representation of the web page, the coordinates where the user 12 clicked are taken, for example, to be the upper left hand corner of an annotation rectangle. When the user clicks again on the image representation, that second click identifies the coordinates of the lower right hand corner of the annotation rectangle. The appropriate scripts then create a semitransparent rectangle overlaid on the browser/client 20 image representation of the web page. This can be done, for example, by causing the appropriate script to create a new HTML DIV element and to set its style properties to appear as a rectangle. The coordinates of the new annotation element would then be sent to the third-party web server 23 and from there to the IM client 224 of the representative 14 so that an identical annotation could be drawn in the window of the IM client 224 by scripts running on the IM client 224.

In some embodiments, the user 12 and representative 14 may be given a choice of annotation “tools.” For example, graphical buttons may be provided so that the user 12 and representative 14 can choose what type of shape to draw. When annotations are drawn, annotations from the user 12 may be shown differently, for example, in a different color, than annotations from the representative 14.

In the description and examples above, the annotations are “vector” annotations that can be defined on the basis of a set of coordinates. However, annotations need not be confined to vector annotations. In some embodiments, bitmapped images may used as annotations; mouse clicks by the user or representative may be used to determine where the image is placed and how large it is.

Once a co-browsing session has been initiated, it may continue for as long as the user 12 and representative 14 desire to continue. Each time the user 12 or representative 14 takes an action, that action is stored in a database on the IM server 22. Both the browser/client 20 and the IM client 224 poll the database on the IM server 22 at regular intervals, looking for actions that have been performed and need to be rendered. Actions may include:
(1) adding graphic annotations (e.g., rectangle, vector, arrow, line, circle, finger-pointer);
(2) clearing or closing the co-browsing window;
(3) loading a particular background image from an image server;
(4) displaying a help graphic or animation;
(5) announcing that a particular user has joined the chat or co-browse; and
(6) adding a line of text to the chat window.

### When the co-browsing is complete, method 300 terminates and returns at task 318.

The above-described embodiments focus on instant message communication between representatives 14 and users 12. However, embodiments of the invention may be used with other modes of communication as well.

Specifically, as was described above, the third-party web server 23 supplies the icon and determines what happens when a user 12 clicks on an icon. Thus, the third-party web server 23 may supply the same or different icons for different modes of communication, and when the user 12 clicks on an icon indicating that live communication with a representative 14 is available, the third-party web server 23 will initiate a mode of communication that is appropriate for the situation and for the characteristics of the particular user 12. Therefore, depending on the capabilities of the clients used by the representatives 14 and the browser/clients used by the users 12, a number of different modes of communication may be used, all without modifying the code that creates the underlying web page.

Accordingly, particularly if multiple modes of communication are available, the decision made by the third-party server 23 may be more complex than the simple decision of whether or not to provide an icon at all. Instead, it may decide not only whether or not to provide an icon, but also which type of icon to provide.

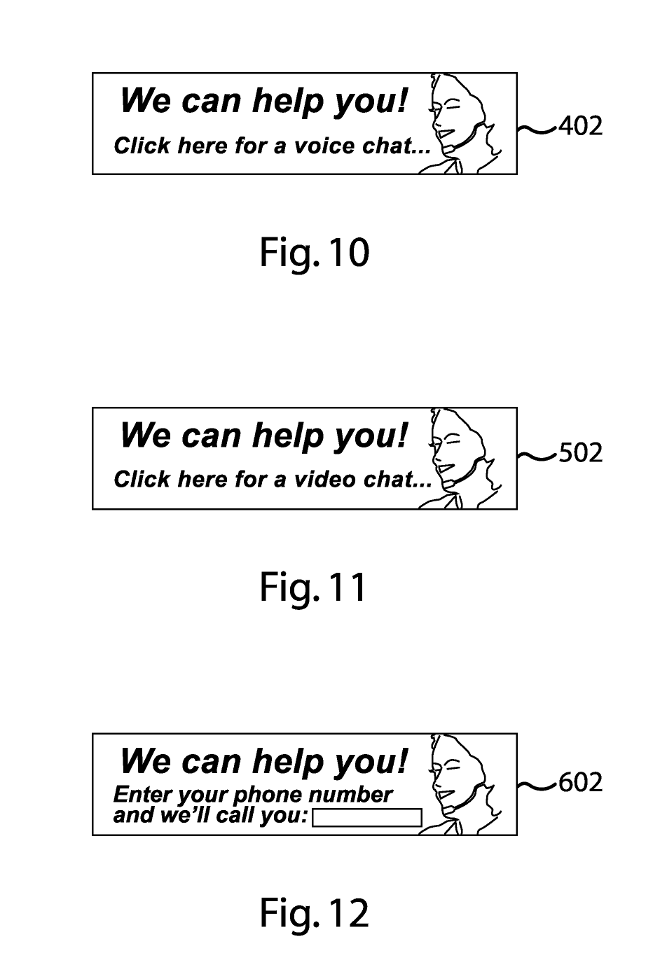

Representative modes of communication include Voice-Over-IP (VoIP) telephony, online videoconferencing, and e-mail, as well as offline or conventional forms of communication, such as callback using standard telephone lines. The icon provided to a user could be different for each mode of communication. For example, FIG. 10 illustrates an icon 402 indicating that a voice chat (using VoIP) is available. Similarly, FIG. 11 illustrates an icon 502 indicating that a video chat is available.

FIG. 12 illustrates an icon 602 indicating that if the user enters his or her telephone number in the field provided for it, a representative will call that user back at that number. FIG. 12 also illustrates another aspect of an icon 502 according to embodiments of the invention; specifically, the icon 502 need not be a static image. Icons according to embodiments of the invention may be dynamic elements capable of accepting information and conveying it to the representatives. However, if static icons are preferred for a particular embodiment or organization, a static icon, when clicked, could cause a window to pop up on the user's screen, and that window could ask for and accept a telephone number or other contact information.

However, each and every user need not be provided with the opportunity to audio chat, video chat, or interact by other modes of communication simply because those modes are available. Instead, the kinds of decision making features described above with respect to determining a user's “worthiness” may be applied to ensure that the users who are offered the opportunity to use those alternative modes of communication are those who are most likely to make the best use of it, or those whose problems are most conducive to resolution using one of the alternative means of communication.

For example, a user may be permitted to use audio or video chat only if he or she has a particular worthiness score or grade, or only if he or she has not been banned from any sites. The criteria may vary from embodiment to embodiment, and each organization may have different criteria. Moreover, an organization may choose to allow only certain modes of communication, or each representative could set his or her own client software to accept or refuse certain modes of communication, and the decision as to what form of communication to provide could be made by polling the available representatives to determine which representatives are currently available and which are allowing or denying particular modes of communication. Representatives may also be provided with the ability to switch from one mode of communication to another as the conversation progresses.

Furthermore, the “worthiness” or user characteristic data may be multidimensional and multimodal; for example, a single user 12 may have a separate worthiness score or grade for each mode of communication, and in some embodiments, behaviors during a conversation using one mode of communication may or may not carry over into interactions using other modes of communication. For example, a user who is banned from video chat may have full rights to instant message communication. In some cases, a user may be prevented from using a particular mode of communication because of low bandwidth or some other technical reason without prejudicing the user's ability to use that mode of communication in the future.

Additionally, as was mentioned above, session information may also be used to determine whether a user is permitted to communicate, and by which means. For example, if a user has a significant amount of merchandise in his or her online shopping cart, that fact alone may entitle the user to a particular mode or modes of communication, irrespective of his or her worthiness score. If that same user does not have a significant amount of merchandise in his or her online shopping cart, he or she may be restricted to e-mail communication, for example.

It should also be understood that the icons shown in FIGS. 10-12 are merely examples. In some embodiments, it may be useful to provide a generic icon, similar to the icon 102 in FIG. 5, which does not indicate a specific mode of communication. When the user clicks on that icon, a script provided by the third-party web server 23 could determine which modes of communication are compatible with the user's browser/client 24, and could also determine which mode of communication to offer the user based on the user characteristic and organizational preference factors described above, before initiating the communication.

The description above also focuses on the use of instant message presence information to alert users that the representatives are away but will return. Those features may be used in embodiments in which there are multiple possible modes of communication.

Any of the methods described above may be rendered in a set of machine-readable instructions on a machine-readable medium interoperable with a machine to perform the tasks of the methods. Machine-readable instructions may be provided in any programming language and stored, for example, on media including floppy disks, hard disk drives, compact disks, digital versatile disks, tape drives, FLASH media, and any other similar machine-readable medium.

While the invention has been described with respect to certain embodiments, the description is intended to be exemplary, rather than limiting. Modifications and changes may be made within the scope of the invention.

What is claimed is:

1. A method of selectively providing access to live customer service over a network, comprising:
determining whether one or more customer service representatives are available;
if one or more representatives is available, providing an indication that communication is available, the indication having the attributes of a link, such that communication between one of the one or more representatives and the user will be initiated when the user activates the link; and
if none of the one or more representatives are available, providing an alternative element;
wherein the indication and the alternative element are provided and have attributes such that the layout of a page rendered with either the indication or the alternative element will be substantially unchanged.

2. The method of claim 1, wherein
the indication is selected from the group consisting of a generic icon indicating that communication is available, an icon indicating that instant message communication is available, an icon indicating that voice communication is available, an icon indicating that e-mail communication is available, an icon indicating that video communication is available, and an icon indicating that callback is available; and
wherein the alternative element comprises a null image.

3. The method of claim 2, wherein the modes of communication are one or more modes selected from the group consisting of e-mail, instant message, voice communication, video chat and callback.

4. The method of claim 1, further comprising:
determining whether a user should be permitted communication with customer service representatives; and
providing the indication if at least one of the one or more representatives is available and the user should be permitted communication.

5. The method of claim 4, wherein the determining comprises examining a user rating given to the user in association with prior communications of the user.

6. The method of claim 5, further comprising, during communication, allowing the representative to set or modify the user rating for the user.

7. The method of claim 4, further comprising, if none of the one or more representatives is available and the user should be permitted communication:
polling presence information associated with the one or more customer service representatives and providing the presence information associated with the representative soonest to become available in association with the indication.

8. The method of claim 7, further comprising, if the presence information includes a relative time-based indication, converting the time-based indication to an absolute time in the local time zone of the user.

9. The method of claim 1, further comprising, once communication between the user and one of the one or more representatives has been initiated:
allowing the user or the representative to indicate a resource;
rendering the resource in image form;
making the image form of the resource available to the user and one or more representatives; and
allowing the user and the representative to annotate the image form and conveying the annotations between the user and the representative substantially in real time.

10. The method of claim 1, wherein the one or both of attributes of the indication and the events that occur when the link is activated depend on one or both of the available modes of communication and characteristics of the user.

11. Machine-readable instructions on a machine-readable medium interoperable with a machine to perform the method of claim 1.

12. A system for selectively providing users access to customer service representatives, comprising:
a first server adapted to provide a page, the page including a reference to a customer service element;
a second server adapted to monitor the communication presence information for at least one customer service representative and to facilitate communication between the at least one customer service representative and one or more users; and
a third server adapted to
communicate with the second server to ascertain whether the at least one customer service representative is available, and
in response to a request from a user's browser,
provide a customer service element indicating that communication with the at least one customer service representative is available if the at least one customer service representative is available, and
provide an alternative customer service element if the at least one customer service representative is not available.

13. The system of claim 12, wherein the request from the user's browser is made in connection with rendering the page from the first server on the user's browser.

14. The system of claim 13, wherein the customer service element indicating that communication is available is an image and the alternative customer service element is a null image.

15. The system of claim 14, wherein the third server is further adapted to determine whether a user should be permitted to communicate with the at least one customer service representative and to provide the customer service element indicating that communication is available if the at least one customer service representative is available and the user should be permitted to communicate with the at least one customer service representative.

16. The system of claim 14, wherein the third server is further adapted to:
convert relative time-based indications in the presence information from the at least one customer service representative into absolute time indications in the user's local time zone; and
provide a customer service element indicating the at least one customer service representative's presence information with the absolute time indications in the user's local time zone if the at least one customer service representative is not available.

17. The system of claim 12, further comprising an image server in communication with at least the third server, the image server being adapted, during communication between the at least one customer service representative, to:
retrieve a resource indicated by either the user or the at least one customer service representative;
render the resource in image form;
distribute the rendered resource to the at least one customer service representative and the user;
allow the rendered resource to be annotated by the at least one customer service representative and the user; and
in cooperation with the other elements of the system, convey the annotations between the user and the at least one customer service representative substantially in real time.

18. The system of claim 12, wherein the first server is maintained by a first organization and the second and third servers are maintained by respective second and third organizations different from the first organization and the same or different from one another.

19. The system of claim 18, further comprising a plurality of first servers, each of the plurality of first servers being distinct and maintained by a different organization, wherein the third server is further adapted to distinguish the one or more customer service representatives belonging to the different organizations from one another.

20. A method of selectively providing access to customer service representatives through a network, comprising, in connection with a request from a user made through the network in the process of retrieving and rendering the components of a page:
determining whether one or more customer service representatives are available for communication;
examining user information to determine whether the user should be permitted to communicate with one of the one or more customer service representatives using one or more modes of communication; and
in response to the request from the user, based on whether one or more customer service representatives are available and whether the user should be permitted to communicate with the customer service representatives, providing either an indication that communication is available or an alternative element, at least the indication serving as a link that, when activated, will initiate communication between the user and one of the one or more representatives;
wherein the indication and the alternative element are provided and have attributes such that the layout of the page rendered with either the indication or the alternative element will be substantially unchanged.

21. The method of claim 20, further comprising:
determining which of the one or more modes of communication the user should be permitted to use to communicate with one of the one or more customer service representatives; and
providing the indication with attributes that reflect the one or more modes of communication that the user should be permitted to use.

22. The method of claim 20, wherein the alternative element has attributes such that it is essentially hidden on the page.

23. Machine-readable instructions on a machine-readable medium interoperable with a machine to perform the method of claim 20.
